(19) United States
(12) Patent Application Publication
(10) Pub. No.: US 2011/0309929 A1
(43) Pub. Date: Dec. 22, 2011

(54) SECURITY SYSTEM WITH KEYFOB ALERT NOTIFICATION

(76) Inventor: Timothy Myers, Prince Albert (CA)

(21) Appl. No.: 13/202,885

(22) PCT Filed: Feb. 24, 2010
(86) PCT No.: PCT/CA2010/000254

§ 371 Date: Aug. 23, 2011

Related U.S. Application Data
(60) Provisional application No. 61/155,198, filed on Feb. 25, 2009.

(51) Int. Cl. G08B 1/08

(52) U.S. Cl. 340/539.11

(57) ABSTRACT

A system and method are provided for notifying a hearing impaired user of one of a plurality of qualified events via a personal device rather than an audible alert to avoid unnecessary false alarms. The security system includes at least one detection device for monitoring a portion of the premises and a control panel configured to communicate with the at least one detection device. A personal device communicates with the control panel where the personal device is configured to mechanically vibrate upon receipt of a signal from the control panel representing a qualified event associated with the security system.

### CROSS-REFERENCE TO RELATED APPLICATION

This application claims the priority benefits of U.S. provisional Application No. 61/155,198 filed Feb. 25, 2009 the entire disclosure of which is incorporated herein by reference.

### BACKGROUND OF THE INVENTION

1.Field of the Invention

Embodiments of the present disclosure relate to security alarm systems and associated methods for protecting residences, businesses and other premises. More particularly, the present disclosure relates to a keyfob used with a security system for qualified events, system status alerts and other system control functions.

2.Discussion of Related Art

Security or alarm systems are installed in premises to detect hazardous or potentially hazardous conditions. A security system generally includes a plurality of detectors/sensors, one or more keypads and a control panel which contains the system electronics and may include a communication interface (communicator) for remote monitoring and two-way communication over telephone or wireless communication paths. Each of the detectors communicates with the control panel to provide notification of an alarm condition. Examples of possible alarm conditions include unauthorized entry or the unexpected presence of a person who may be an intruder, fire, smoke, toxic gas, high/low temperature conditions (e.g., freezing), flooding, power failure, etc. In other words, an alarm condition may represent any detectable condition that might lead to personal hazard or property damage. Audible and/or visible alarm devices such as sirens, lights, etc., may also be utilized to notify occupants of the existence of an alarm condition. The control panel may be located in a utility room, basement, etc., and may communicate with the detectors and notification devices by wired or wireless signal paths. A keypad, which may also communicate with the control panel via a wired or wireless connection, is used to arm/disarm the system as well as providing a means to display various system messages via a status display screen.

A typical security system includes an “exit delay” and an “entry arming delay.” An entry delay is preprogrammed into the security system to allow a homeowner with sufficient time to disarm the alarm system. These delay times may be, for example, 60 seconds, but have been getting longer in view of fines assessed by certain municipalities for false alarms. During this entry delay time, an audible alert or warning sound notifies the user that they must disarm the system. However, for users that are deaf or hearing impaired, this audible warning may not be heard or may be drowned out by other nearby loud noises.

An exit arming delay allows the end user sufficient time to exit the protected premises after arming the security system without triggering an alarm condition. Such a delay begins when the user arms the system using the keypad before exiting the premises. However, a user may arm the system and exit the premises, but may inadvertently leave a door, window or other detected condition open. If the user is hearing impaired, they will not be alerted to this condition by the audible warning. The system will go into alarm causing a false alarm to be sent to the monitoring service.

Attempts have been made to solve these problems by using visual annunciators such as lights to alert the user of the need to disarm the system before an alarm event notification is sent to a monitoring facility and/or to the local authorities. However, a user may not notice these visual annunciators if, for example, they are improperly mounted or poorly placed in the premises with respect to the user. In addition, these visual annunciators may not alert a hearing impaired or deaf person that they have not armed the system when leaving the premises.

U.S. Publication No. 2008/0303657 entitled “Life Safety Device for the Hearing Impaired” discloses the use of a life safety pendant that is used to send a panic message to a central monitoring facility. A central home panel processes an alarm event and controls vibration of the pendant to communicate the event to a hearing challenged user. However, the pendant and associated system do not provide the user with status information before an alarm event occurs nor does it notify the user of system status information. This is critical since without such notification, unnecessary false alarms may be transmitted to the monitoring facility. For example, if a hearing impaired user enters the premises where an alarm system is activated, the user must disarm the alarm within the entry delay period. Prior art systems do not provide notification to the user by vibrating the pendant to indicate that the alarm is activated and must be disarmed. Rather, a hearing impaired user is only notified once the alarm event is sent to the monitoring station which is too late to prevent unnecessary false alarms. Thus, it is an object of the present disclosure to provide a keyfob or other personal device that communicates alarm status information to a hearing challenged user before false alarms are triggered.

### SUMMARY OF THE INVENTION

Exemplary embodiments of the present disclosure are directed to a device and method for providing vibrational alerts to a user of a security system. In an exemplary embodiment, such a method for monitoring a premises includes detecting one of a plurality of qualified events at the premises. A signal is sent from the control panel to a personal device in response to detection of one of the plurality of qualified events. The personal device vibrates in response to the received signal to notify a user of the qualified event.

In another exemplary embodiment, a security system for protecting a premises includes at least one detection device for monitoring a portion of the premises and a control panel that communicates with the at least one detection device. A personal device communicates with the control panel and is configured to mechanically vibrate upon receipt of a signal from the control panel representing a qualified event associated with the security system.

### BRIEF DESCRIPTION OF THE DRAWINGS

FIG. 1 illustrates a block diagram of an exemplary security system in accordance with an embodiment of the present disclosure.

FIG. 2 is a flow chart of an exemplary status notification process utilizing the security system of FIG. 1 in accordance with an embodiment of the present disclosure.

### DESCRIPTION OF EMBODIMENTS

The present disclosure will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

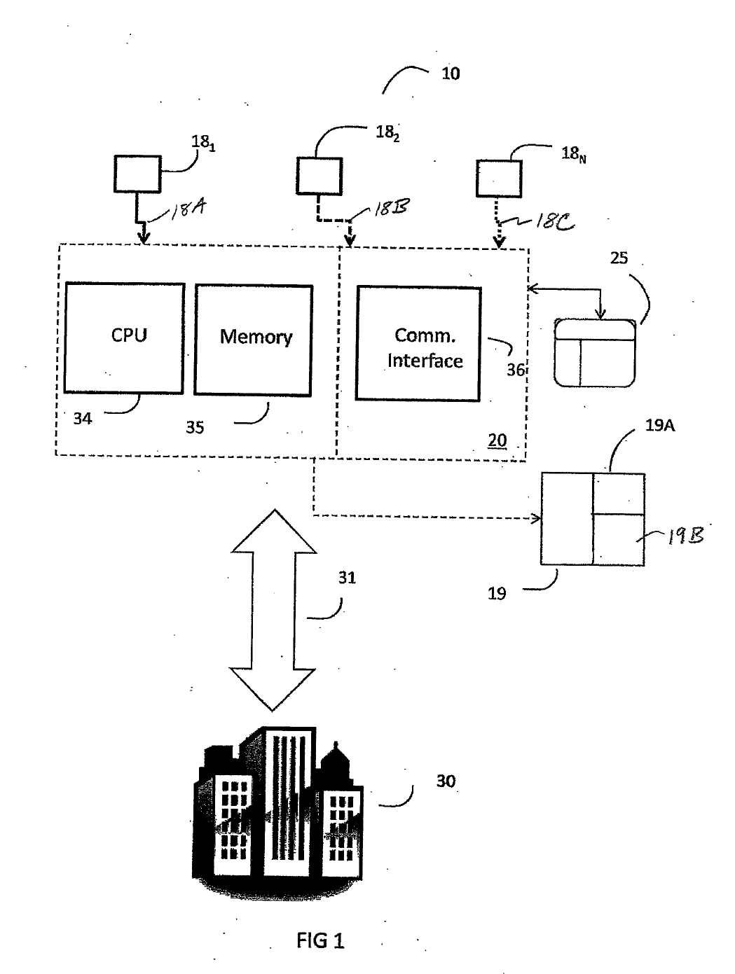

FIG. 1 is a block diagram of a typical security system 10 embodying the present disclosure installed in a building or premises. Security system 10 includes a control panel 20 which generally controls operation of the system. A number of detection devices 18₁ . . . 18_{N} are utilized to monitor an area. Detection devices may include, for example, motion detectors, door contacts, glass break detectors, smoke detectors, water leakage detectors, gas detectors, etc. Detection devices 18₁ . . . 18_{N} communicate with panel 20 by a dedicated wired interconnect 18A, wirelessly 18B, through the electric (i.e. power) wiring of the premises 18C, or otherwise. One or more user interfaces, such as keypad 25 is used to communicate with control panel 20 to arm, disarm, notify and generally control system 10. The alarm system 10 further includes a portable personal device 19 such as, for example, a keyfob or pendant, used to provide vibrational notification to a user as explained in more detail below.

Control panel 20 communicates with each of the detection devices 18₁ . . . 18_{N}, keypad 25 and personal device 19 as well as communicating with an offsite monitoring service 30 which is typically geographically remote from the monitored premises in which system 10 is installed. Control panel 20 may include a CPU 34, memory 35 and communicator 36. CPU 34 functions as a controller to control the various communication protocols within system 10. Memory 35 stores system parameters, detection device information, address information etc. Communicator 36 sends and receives signals to/from the monitoring facility 30 via communications link 31. Alternatively, communicator 36 may be a separate device that communicates with controller 20 via a hardwired or wireless connection.

Generally, when an alarm condition occurs based on the operation of one or more detection devices 18₁ . . . 18_{N}, a signal is transmitted from the respective detection device to control panel 20. Depending on the type of signal received from the one or more detection devices, communicator 36 communicates with monitoring service 30 via link 31 to notify the monitoring service that an alarm notification has occurred at the premises. Communication link 31 may be a POTS (Plain Old Telephone System) connection, a broadband connection (e.g., internet), a cellular link such as GSM (Global System for Mobile communications) transmission, etc. In certain security systems, keypad 25, control panel 20 and communicator 36 may be housed within a single unit.

As noted above, keypad 25 is used to communicate with control panel 20 to arm, disarm, notify and generally control system 10. Keypad 25 includes a status display which may include either individual indicators, such as discrete light emitting diodes or may include an LCD or LED display, capable of displaying messages regarding the status of particular detection devices 18₁ . . . 18_{N} and/or operation of the system. Keypad 25 may include an audible device to notify a user to disarm the armed system. However, users that are hearing impaired cannot hear this audible alert.

Personal device 19 incorporates a component that creates the effect of mechanical movement of the device 19 such as, for example, vibration motor 19a. The vibration motor 19a causes device 19 to vibrate based on a received signal from control panel 20. The personal device 19 may be activated in response to qualified events such as, for example, entry delay, system trouble, system failed to arm, or other similar conditions. As used herein, “qualified event” means (1) a system event which, but for user intervention, would trigger an alarm; (2) a change in system or component status when the system is not armed; or (3) state or condition of alarm after notification to an offsite monitoring service to notify a user arriving at a premises that the system has gone into alarm.

The personal device 19 may be in the user's pocket, hand or apparel where the vibration is easily felt or may be associated with a user's automobile (e.g. keys, garage door opener), etc. The personal device 19 obviates the need for audible sounders which are impractical for hearing impaired users and avoids installation of bulky devices installed in the premises that will create vibrations to alert the user. Instead, a hearing impaired user simply needs to carry the personal device 19 which will vibrate in response to the received signal. In this manner, unnecessary false alarms can be avoided by disarming or entering control commands after receiving vibrational notification via personal device 19.

Personal device 19 is used to notify a user of a qualified event. For example, personal device 19 vibrates to alert a hearing impaired user entering the secured premises that an alarmed system must be disarmed during the entry delay period. When the portable personal device 19 receives the signal, it activates the vibration motor therein which alerts a user that the system needs to be disarmed before an alarm event is processed. Once notified, the user may disarm the system by entering a unique pin code via keypad 25. This is particularly advantageous in the case where a user is hearing impaired and will be alerted by the vibration of the personal device 19 notifying the user that the system or device requires action. Upon alert, the user may enter the unique access code (sometimes referred to as a PIN) via keypad 25 to disarm system 10. After disarming, control panel 20 sends a signal to the personal device 19 stopping vibration thereof.

Alternatively, vibrational notification may be stopped by the user pressing a control or function key on device 19. In addition, personal device 19 may be programmed to provide different vibration patterns depending on the type of qualified event. For example, to notify a user that the alarm is activated and must be disarmed during the entry delay period, control panel 20 may send a signal to device 19 causing it to vibrate constantly and/or change the vibration pattern when a certain number of seconds are left for the entry delay period. In order to notify a user that the alarm system is malfunctioning, control panel 20 may send a signal to device 19 causing it to vibrate intermittently or to produce pulsed vibrations. Particular vibrational patterns may be associated with specific system conditions.

Another example of notification of a qualified event is when a user arrives at the premises where the system has gone into alarm. Control panel 20 will send a signal that vibrates personal device 19 alerting the hearing impaired user not to enter the premises. In addition, system 10 may be configured to notify a user via vibration of the personal device 19 when a detector is triggered in a non-alarm state. This may occur, for example, when a hearing impaired user is at the premises and the system in unarmed, but a detector in a zone is triggered. Control panel 20 sends a signal to the personal detector 19 alerting the hearing impaired user that a detector such as, for example, a door sensor, has been triggered. Additionally, system 10 may be configured to send a signal to personal device 19 from control panel 20 when a particular zone is bypassed. This represents a change in status of the system, but is not an event in which notification to offsite monitoring services is required.

Personal device 19 may further be configured to provide a vibrational alert to a hearing impaired user when system 10 is armed, and the user exits the premises, but inadvertently left a door, window, etc., open. If the user is hearing impaired, they will not be alerted to this condition by an audible warning. Control panel 20 sends a signal to the personal device 19 which causes the device to vibrate via motor 19A and alerts the user. Without the hearing impaired user being alerted to this condition by personal device 19, an alarm notification would be sent to the offsite monitoring service by control panel 20 at the expiration of the exit delay period thereby causing a false alarm.

The personal device 19 may also include function keys which may be used, for example, to arm the security system based on a qualified event. For example, a user that exits the premises without activating the alarm may receive vibrational notification via the personal device 19 that the system is not armed. The personal device may include one or more function keys thereon, that when pressed, may send a signal to the control panel 20 to perform a certain function such as, for example, activating the alarm, disarming the alarm, etc. If the user does not want to arm the system, then the personal device may still provide vibrational notification, but the user may choose not to press the appropriate function key to arm the system. To accommodate these functions, personal device may include a transmitter 19B which functions to send a signal to the control panel 20 when one or more function keys are activated. The function keys may also be used to stop vibration of the personal device 19. When a particular function key on the personal device 19 is pressed, motor 19A stops vibrating.

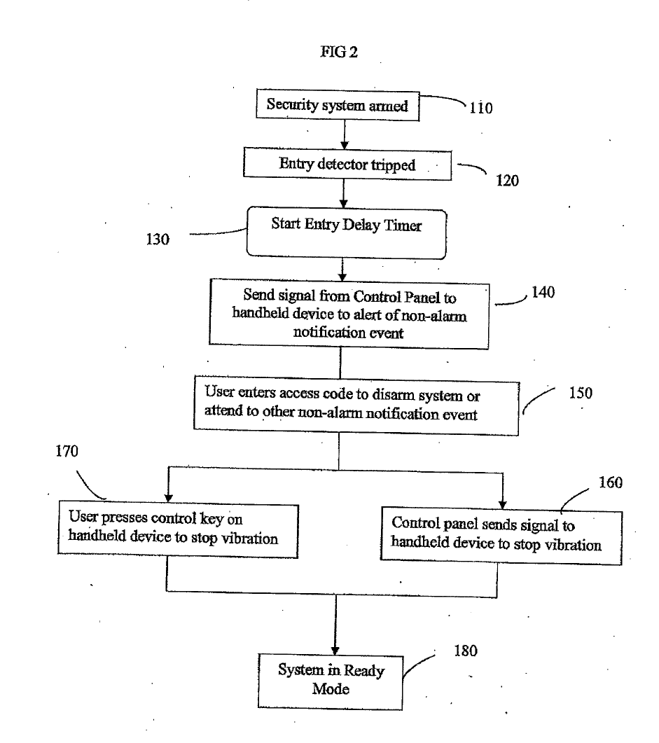

FIG. 2 is a flow chart illustrating an exemplary operation of security system 10 utilizing the personal device 19 to notify a user of a qualified event, for example system disarming before expiration of an entry delay. Of course, the personal device 19 may be utilized to alert a hearing impaired user of other qualified events including, but not limited to, exit delay, alarm time out after occurrence of an alarm event, system malfunctions (communicator link faults, low battery, loss of system power, etc.), zone chime control, and activation of programmable outputs (e.g. garage door activation), etc.

In particular, when a person enters the premises wherein the security system is armed at step 110, the associated detection device 18₁ . . . 18_{N}, typically one or more door contacts (e.g. 18_{N}), is activated or tripped at step 120. Once activated, the detection device transmits a signal to control panel 20. Keypad 25 which is usually located near an entry/exit door receives a signal from control panel 20 to initiate an audible alert (e.g. warning beeps) to notify the entering person to disarm system 10. Control panel 20 provides an entry delay period at step 130 for the person entering the premises to enter an access code to disarm the system. The duration of this entry delay period is stored in memory 35 and may range from 30 seconds to more than a minute.

However, for a user that is hearing impaired, these audible alarms would previously have gone unnoticed. Control panel 20 sends a signal to personal device 19 at step 140. The personal device vibrates in response to the received signal. Upon vibrational alert, the user may enter the unique access code via keypad 25 to disarm system 10 (or attend to other qualified event) at step 150. After disarming, control panel 20 sends a signal to the personal device 19 stopping vibration thereof at step 160. Alternatively, vibrational notification may be stopped by the user pressing a control key on device 19 at step 170. At step 180, the security system 10 is in ready mode.

The process described herein may be automated by, for example, tangibly embodying a program of instructions in memory 35 capable of being read by a machine which executes these instructions. The CPU 34 is one example of such a machine. The functions and process steps herein may be performed automatically or wholly or partially in response to user commands. A step performed automatically is performed in response to one or more executable instructions or device operations without user initiation of the activity.

While the present invention has been disclosed with reference to certain embodiments, numerous modifications, alterations and changes to the described embodiments are possible without departing from the sphere and scope of the present disclosure, as defined in the appended claims. Accordingly, it is intended that the present invention not be limited to the described embodiments, but that it has the full scope defined by the language of the following claims, and equivalents thereof.

What is claimed is:

1. A method for monitoring a premises comprising:
detecting one of a plurality of system qualified events at the premises;
sending a signal from a control panel to a personal device in response to detection of one of said plurality of system qualified events; and
vibrating said personal device in response to said signal to notify a user of said one of plurality of system qualified events.

2. The method of claim 1 further comprising sending a signal from a control panel located at the premises to said personal device to stop vibration thereof.

3. The method of claim 1 in which said vibration has a pattern associated with a particular one of a plurality of system qualified events.

4. The method of claim 1 further comprising stopping vibration of said personal device by pressing a control key on said personal device.

5. A security system for protecting a premises comprising:
at least one detection device for monitoring a portion of the premises;
a control panel configured to communicate with said at least one detection device; and
a personal device communicating with the control panel, said personal device configured to mechanically vibrate upon receipt of a signal from said control panel representing a qualified event associated with said security system.

6. The security system of claim 5 wherein said personal device comprises a motor configured to vibrate said personal device in response to said control signal.

7. The security system of claim 6 wherein said control signal is a first of a plurality of control signals and said qualified event is a first of a plurality of qualified events, said motor configured to vibrate at a first pattern associated with said first of said plurality of control signals to communicate said first of the plurality of qualified events.

8. The security system of claim 7 wherein said motor is configured to vibrate at a second pattern associated with a second of said plurality of control signals wherein said first pattern is different from said second pattern.

9. The security system of claim 5 wherein the personal device is a keyfob.

10. The security system of claim 5 wherein said qualified event represents system status information.
